(19) United States
(12) Patent Application Publication
(10) Pub. No.: US 2015/0229125 A1
(43) Pub. Date: Aug. 13, 2015

(54) ELECTROSTATIC PROTECTION CIRCUIT

(71) Applicant: KABUSHIKI KAISHA TOSHIBA, Tokyo (JP)

(72) Inventors: Kazuhiro KATO, Yokohama Kanagawa (JP); Takehito IKIMURA, Yokohama Kanagawa (JP)

(21) Appl. No.: 14/475,520

(22) Filed: Sep. 2, 2014

(30) Foreign Application Priority Data
Feb. 10, 2014 (JP) 2014-023440

(51) Int. Cl. H02H 9/04

(52) U.S. Cl. CPC H02H 9/044

(57) ABSTRACT

According to one embodiment, an electrostatic protection circuit includes a first trigger circuit that is connected between a first power supply terminal and a second power supply terminal, and a second trigger circuit. The circuit includes a first buffer circuit that outputs a drive signal in response to a trigger signal of the first trigger circuit, and a second buffer circuit that outputs a drive signal in response to a trigger signal of the second trigger circuit. A shunt circuit includes a first switch circuit and a second switch circuit connected in series between the first and second power supply terminals. A conduction of the first switch circuit is controlled by a drive signal of the first buffer circuit, and a conduction of the second switch circuit is controlled by a drive signal of the second buffer circuit.

### CROSS-REFERENCE TO RELATED APPLICATION

This application is based upon and claims the benefit of priority from Japanese Patent Application No. 2014-023440, filed Feb. 10, 2014, the entire contents of which are incorporated herein by reference.

### FIELD

Embodiments described herein relate generally to an electrostatic protection circuit.

### BACKGROUND

Recently, various proposals on a protection circuit with regard to an electrostatic discharge (ESD) have been made. The ESD means a discharge from a person or a machine which is charge-electrified to a semiconductor device, or a discharge from the charge-electrified semiconductor to a ground potential, or the like. If the ESD occurs with respect to the semiconductor device, a large amount of electric charge from a terminal thereof becomes current that flows into the semiconductor device. The electric charge generates a high voltage inside the semiconductor device, thereby causing an insulation breakdown of an internal element or a failure of the semiconductor device.

As a representative example of an electrostatic protection circuit, there is an RC triggered (RCT) MOS circuit which has a trigger circuit configured with a series circuit of a resistor and a capacitor is connected between power supply terminals, in which a MOS transistor for discharging is driven by using a voltage at a common node of the resistor and the capacitor as a trigger signal. Since the ON time of the MOS transistor for discharging is determined by a time constant of the trigger circuit, the time constant is set so as to sufficiently discharge the ESD surge. However, if the time constant is large, the trigger circuit responds to a variation of a power supply voltage or a fluctuation of the power supply voltage due to operation of the internal circuit when the power supply starts, and there is a possibility that the MOS transistor for discharging unintentionally operates in spite of no ESD surge. If the MOS transistor for discharging unintentionally operates when the power supply starts, there is a case in which the power supply voltage does not sufficiently start, and an operation failure of the internal circuit occurs. In addition, the trigger circuit responds to the fluctuation of the power supply voltage, and thereby, when the MOS transistor for discharging is ON for a long time, there is a concern that a situation occurs in which the MOS transistor for discharging itself is led to a breakdown.

### DESCRIPTION OF THE DRAWINGS

FIG. 1 is a diagram illustrating an electrostatic protection circuit according to a first embodiment.

FIG. 2 is a diagram illustrating an electrostatic protection circuit according to a second embodiment.

FIG. 3 is a diagram illustrating an electrostatic protection circuit according to a third embodiment.

### DETAILED DESCRIPTION

The embodiment provides an electrostatic protection circuit which may prevent an unintentional operation and sufficiently discharge ESD surge.

In general, according to one embodiment, an electrostatic protection circuit includes a first power supply terminal, and a second power supply terminal. The circuit includes a first trigger circuit that is connected between the first power supply terminal and the second power supply terminal, and a second trigger circuit that is connected in parallel to the first trigger circuit between the first power supply terminal and the second power supply terminal. The circuit includes a first buffer circuit that outputs a drive signal in response to a trigger signal of the first trigger circuit, and a second buffer circuit that outputs a drive signal in response to a trigger signal of the second trigger circuit. The circuit includes a shunt circuit that includes a first switch circuit and a second switch circuit connected in series between the first and second power supply terminals. A conduction of the first switch circuit is controlled by the drive signal of the first buffer circuit, and a conduction of the second switch circuit is controlled by the drive signal of the second buffer circuit.

An electrostatic protection circuit according to the exemplary embodiments is described with reference to the attached drawings in detail. In addition, the embodiments are not limited thereto.

### First Embodiment

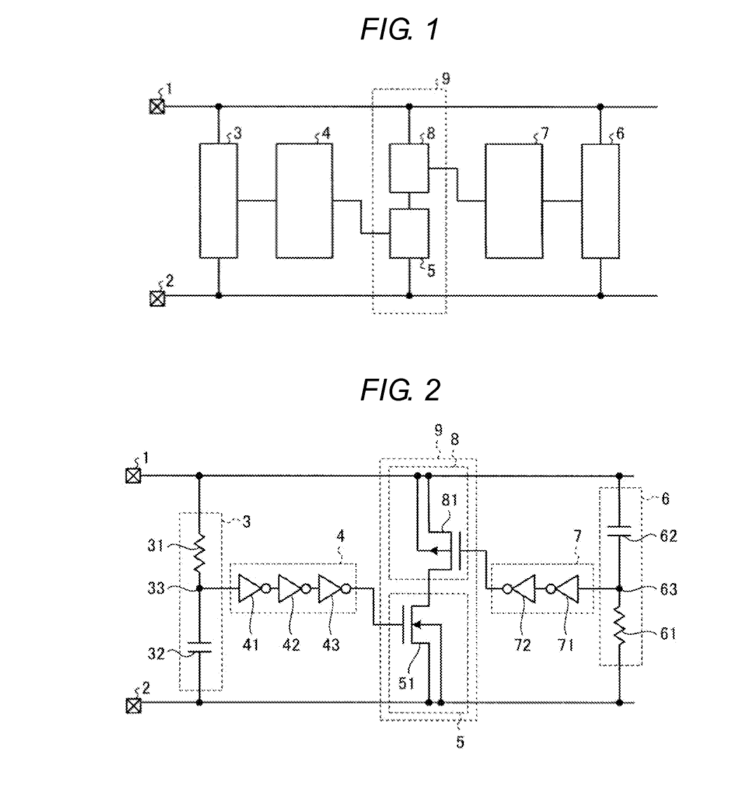

FIG. 1 is a diagram illustrating an electrostatic protection circuit according to a first embodiment. The electrostatic protection circuit according to the embodiment includes a first trigger circuit 3 which is connected between a first power supply terminal 1 and a second power supply terminal 2. A trigger signal of the first trigger circuit 3 is supplied to a first buffer circuit 4. The first buffer circuit 4 amplifies the trigger signal from the first trigger circuit 3, and supplies the amplified trigger signal to a first switch circuit 5. A conduction of the first switch circuit 5 is controlled by a drive signal from the first buffer circuit 4.

A second trigger 6 and the first trigger circuit 3 are connected together in parallel between the first power supply terminal 1 and the second power supply terminal 2. A trigger signal of the second trigger circuit 6 is supplied to a second buffer circuit 7. The second buffer circuit 7 amplifies the trigger signal from the second trigger circuit 6, and supplies the amplified trigger signal to a second switch circuit 8. A conduction of the second switch circuit 8 is controlled by a drive signal from the second buffer circuit 7. Main current paths of the first switch circuit 5 and the second switch circuit 8 are connected in series between the first power supply terminal 1 and the second power supply terminal 2, and configure a shunt circuit 9. An internal circuit is connected between the first power supply terminal 1 and the second power supply terminal 2, but is omitted.

A predetermined voltage is applied between the first power supply terminal 1 and the second power supply terminal 2, and in a normal state where the internal circuit (not illustrated) operates normally, a drive signal which causes the first switch circuit 5 to be switched OFF is supplied from the first buffer circuit 4 to the first switch circuit 5. In contrast, a drive signal which causes the second switch circuit 8 to be switched ON is supplied from the second buffer circuit 7 to the second switch circuit 8. Since the first switch circuit 5 which configures the shunt circuit 9 is OFF, the shunt circuit 9 is in an OFF state in the normal state where the predetermined voltage is applied between the first power supply terminal 1 and the second power supply terminal 2.

When an ESD surge is applied between the first power supply terminal 1 and the second power supply terminal 2, the first trigger circuit 3 supplies the trigger signal to the first buffer circuit 4 in response to the ESD surge. The first buffer circuit 4 amplifies the trigger signal and supplies the drive signal to the first switch circuit 5. The switch circuit 5 is turned ON in response to the drive signal of the first buffer circuit 4. The second trigger circuit 6 is set so as not to respond to the ESD surge, and the second switch circuit 8 remains as an ON state. Due to this, with respect to the ESD surge, both the first switch circuit 5 and the second switch circuit 8 of the shunt circuit 9 enter an ON state, and thereby discharging the ESD surge.

There is a case where a variation of a voltage which starts more rapidly than the ESD surge (a power supply voltage variation event) occurs between the first power supply terminal 1 and the second power supply terminal 2. For example, there is a case where, when a power supply voltage starts, a variation of the power supply voltage which is rapidly started by an operation of a charge pump (not illustrated) occurs. In this case, both the first trigger circuit 3 and the second trigger circuit 6 respond to the variation of the power supply voltage. As the first trigger circuit 3 responds, the trigger signal is supplied from the first trigger circuit 3 to the first buffer circuit 4, and the drive signal is supplied from the first buffer circuit 4 to the first switch circuit 5. As a result, the first switch circuit 5 is turned ON. In contrast, as the second trigger circuit 6 responds, the trigger signal is supplied from the second trigger circuit 6 to the second buffer circuit 7, and the drive signal is supplied from the second buffer circuit 7 to the second switch circuit 8. As a result, the second switch circuit 8 enters an OFF state. That is, the second switch circuit 8 which is in an ON state in the normal state receives the drive signal of the second buffer circuit 7 and enters an OFF state. As a result, when the variation of the voltage which starts more rapidly than the ESD surge occurs between the first power supply terminal 1 and the second power supply terminal 2, the shunt circuit 9 enters an OFF state.

According to the present embodiment, the electrostatic protection circuit includes two trigger circuits 3, 6 which are connected in parallel between the first power supply terminal 1 and the second power supply terminal 2. Thus, a response characteristic with respect to the variation and the like of the power supply voltage of the first and second trigger circuits 3, 6 may be separately set, respectively. For example, the first trigger circuit 3 may be set to a characteristic responding to the ESD surge and the variation of the power supply voltage which starts faster than the ESD surge. In contrast, the second trigger circuit 6 may be set to a characteristic responding only to the variation and the like of the power supply voltage which starts faster than the ESD surge. The conduction of the two switch circuits 5 and 8 which configure the shunt circuit 9 is controlled by the drive signal of the buffer circuits 4, 7 which amplify and output the trigger signal of each of the trigger circuits 3, 6. Since the shunt circuit 9 enters an ON state only when the two switch circuits 5, 8 which are connected together in series are ON, the shunt circuit 9 may be configured so as not to operate, with respect to the variation and the like of the power supply voltage which starts more rapidly than the ESD surge. That is, with respect to the variation of the power supply voltage when the power supply voltage starts or the like, the electrostatic protection circuit in which the shunt circuit 9 does not unintentionally operate may be provided.

### Second Embodiment

FIG. 2 is a diagram illustrating an electrostatic protection circuit according to a second embodiment. The same reference numerals and symbols are attached to the configuration elements corresponding to those of the above-described embodiment. In the present embodiment, the first trigger circuit 3 includes a series circuit of a resistor 31 and a capacitor 32. A common node 33 of the resistor 31 and the capacitor 32 is connected to the first buffer circuit 4. The first buffer circuit 4 includes three-stages of inverters 41, 42, 43 which are connected in series. Each of the inverters 41, 42, 43 is configured with, for example, a CMOS inverter. The first buffer circuit 4 amplifies the trigger signal from the first trigger circuit 3, and supplies the drive signal to the first switch circuit 5. The first switch circuit 5 includes an NMOS transistor 51. The drive signal from the first buffer circuit 4 is supplied to a gate electrode of the NMOS transistor 51. A source electrode and back gate electrode of the NMOS transistor 51 are connected to the second power supply terminal 2.

The second trigger circuit 6 includes a series circuit of a resistor 61 and a capacitor 62. A common node 63 of the resistor 61 and the capacitor 62 is connected to the second buffer circuit 7. The second buffer circuit 7 includes two-stages of inverters 71, 72 which are connected in series. Each of the inverters 71, 72 is configured with, for example, a CMOS inverter. The second buffer circuit 7 amplifies the trigger signal from the second trigger circuit 6, and supplies the drive signal to the second switch circuit 8. The second switch circuit 8 includes a PMOS transistor 81. The drive signal from the second buffer circuit 7 is supplied to a gate electrode of the PMOS transistor 81. A source electrode and back gate electrode of the PMOS transistor 81 are connected to the first power supply terminal 1.

A drain electrode of the NMOS transistor 51 is connected to a drain electrode of the PMOS transistor 81. A source-drain current path of the NMOS transistor 51 and the PMOS transistor 81 which are a main current path is connected in series between the first power supply terminal 1 and the second power supply terminal 2, and the NMOS transistor 51 and the PMOS transistor 81 configure the shunt circuit 9.

For example, a time constant of a RC circuit which is configured with the resistor 31 and the capacitor 32 which configure the first trigger circuit 3 is set to a value which meets an ESD test standard. In an ESD human body charge-electrification model (HBM law: Human body model), a test in which the electric charges that are charged to 100 pF (picofarad) are discharged via a resistor of 1.5 kΩ (kilo-ohm) is performed. Due to this, the time constant of the first trigger circuit 3 is set to 1 μS (micro-second) which is a value of six to seven times 150 nS, for example, in consideration of the time constant of 150 nS (nano-seconds) set by the capacitor of 100 pF and the resistor of 1.5 kΩ which are an ESD test standard. This is sufficient for discharging the ESD surge. For example, by setting a value of the resistor 31 to 1 MΩ (megohm) and by setting a value of the capacitor 32 to 1 pF, the time constant is set to 1 μS.

The time constant of the RC circuit which is configured with the resistor 61 and the capacitor 62 which configure the second trigger circuit 6 is set based on a circuit operation speed of the internal circuit (not illustrated) which is connected between the first power supply terminal 1 and the second power supply terminal 2, or a speed of a voltage start of the charge pump (not illustrated) when the power supply starts. The setting enables the second trigger circuit 6 to respond to the variation of the power supply voltage caused by the operation of the internal circuit, or the variation of the power supply voltage when the power supply starts. By causing second trigger circuit 6 to respond to the variation of the power supply voltage caused by the operation of the internal circuit, or the variation of the power supply voltage when the power supply starts, the PMOS transistor 81 which configures the second switch circuit 8 is turned OFF, thereby maintaining the shunt circuit 9 in an OFF state. That is, with respect to the variation of the power supply voltage caused by the operation of the internal circuit, or the variation of the power supply voltage when the power supply starts, a configuration is made in which no shunting between the first power supply terminal 1 and the second power supply terminal 2 occurs.

For example, when the power supply starts, the time when the power supply voltage starts using the charge pump (not illustrated) is on the order of 100 pS (picoseconds), the time constant of the second trigger circuit 6 is set to, for example, 1 nS (nanosecond). As the time constant of the second trigger circuit 6 is set to a value of approximately 10 times the time when the power supply voltage starts, the second trigger circuit 6 responds to a fast variation of the power supply voltage when the power supply starts, or the like. As the second trigger circuit 6 responds, the drive signal of a high level is supplied from the second buffer circuit 7 to a gate electrode of the PMOS transistor 81, and the PMOS transistor 81 is switched to an OFF state. That is, the shunt circuit 9 is in an OFF state.

When the ESD surge is applied between the first power supply terminal 1 and the second power supply terminal 2, the first trigger circuit 3 responds and supplies the trigger signal to the first buffer circuit 4. A high-level drive signal is supplied from the first buffer circuit 4 to the gate electrode of the NMOS transistor 51, and the NMOS transistor 51 enters the ON state. In contrast, since the time constant of the second trigger circuit 6 is set to a small time constant of approximately 1 nS, there is no responding to the ESD surge with a rising time of approximately 10 nS, for example. Due to this, the drive signal of a low level is supplied from the second buffer circuit 7 to the gate electrode of the PMOS transistor 81, and the PMOS transistor 81 enters the ON state. As a result, with respect to the ESD surge, both the NMOS transistor 51 which configures the first switch circuit 5 and the PMOS transistor 81 which configures the second switch circuit 8 enter the ON state, and thus, the shunt circuit 9 between the first power supply terminal 1 and the second power supply terminal 2 enters the ON state, discharging the ESD surge.

In a normal state where the predetermined voltage is applied between the first power supply terminal 1 and the second power supply terminal 2, for example, in a normal state where a voltage VDD of a high potential side is applied to the first power supply terminal 1, a ground potential VSS is applied to the second power supply terminal 2, and the internal circuit (not illustrated) performs a general operation, a signal of a high level is supplied from a common node 33 of the first trigger circuit 3 to the first buffer circuit 4. Since the drive signal of a low level is supplied from the first buffer circuit 4 to the gate electrode of the NMOS transistor 51 of the first switch circuit 5, the NMOS transistor 51 is in an OFF state. In contrast, a signal of a low level is supplied from a common node 63 of the second trigger circuit 6 to the second buffer circuit 7, the drive signal of a low level is supplied to the gate electrode of the PMOS transistor 81 of the second switch circuit 8, and the PMOS transistor is in the ON state. That is, since the first switch circuit 5 which configures the shunt circuit 9 is in an OFF state, the shunt circuit 9 is in the OFF state, in a normal state where the predetermined voltage is applied between the first power supply terminal 1 and the second power supply terminal 2.

According to the present embodiment, the time constants of the first trigger circuit 3 and the second trigger circuit 6 are set, and thereby ESD surge may be discharged, and with respect to the variation of the power supply voltage when the power supply starts faster than the ESD surge, the electrostatic protection circuit in which the shunt circuit maintains an OFF state may be provided. That is, with respect to the variation of the power supply voltage when the power supply starts or the like, the electrostatic protection circuit is provided in which the shunt circuit 9 does not unintentionally operate. In addition, since the time constant of the first trigger circuit 3 may be set to a large value, the ESD surge may be sufficiently discharged. For example, when the time constants of the first trigger circuit 3 and the second trigger circuit 6 are compared with each other, the time constant of the second trigger circuit 6 is set to a value of approximately 1/1,000 times, with respect to the time constant of the first trigger circuit 3. In other words, the time constant of the first trigger circuit 3 may be set to a value of approximately 1000 times the time constant of the second trigger circuit 6.

### Third Embodiment

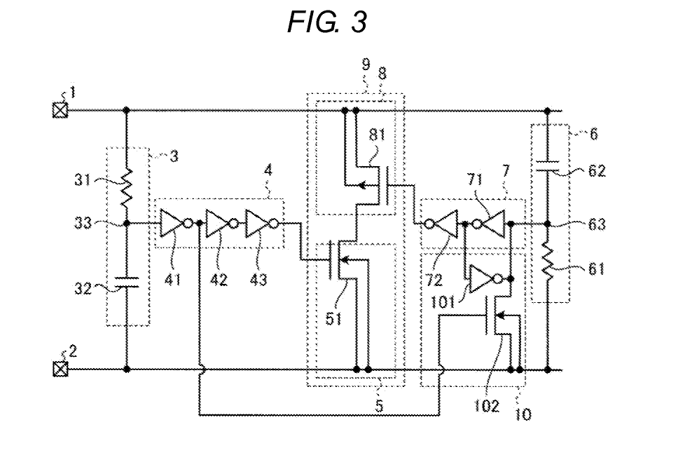

FIG. 3 is a diagram illustrating an electrostatic protection circuit according to a third embodiment. The same reference numerals and symbols are attached to the configuration elements corresponding to those of the above-described embodiments, and description thereof is omitted. The present embodiment includes a retaining unit 10 which retains a level of an input signal of the second buffer circuit 7 for a predetermined time. The retaining unit 10 includes an inverter 101 which is connected in reverse-parallel to an inverter 71 of the second buffer circuit 7. The inverter 101 is configured with a CMOS inverter, for example. A feedback circuit is configured in which if a potential at a common node 63 changes to a high level, an output signal of a low level is supplied from the inverter 71 to an inverter circuit 102, and a signal of a high level is supplied from the inverter 102 to the inverter 71. By the feedback circuit, an input signal level of an input terminal of the inverter 71, that is, the level of the trigger signal which is supplied to the second buffer circuit 7 is maintained in a high level. The feedback circuit configured with the inverter 71 and the inverter 101 configures a so-called latch circuit. The retaining unit 10 includes an NMOS transistor 102 for reset. A gate electrode of the NMOS transistor 102 receives an output of an inverter 41 of the first buffer circuit 4. A source electrode and a back gate electrode of the NMOS transistor 102 are connected to the second power supply terminal 2, and a drain electrode of the NMOS transistor 102 is connected to an output terminal of the inverter 101.

As described above, in order to respond to the variation or the like of the power supply voltage when the power supply starts faster than the ESD surge, the time constant of the second trigger circuit 6 is set to a small value. Due to this, the potential at the common node 63 of the second trigger circuit 6 changes to a high level in a short time, but the potential rapidly changes to a low level due to the short time constant. With the retaining unit 10, the level of the input signal of the second buffer circuit 7 is maintained in a high level for a predetermined time, and thereby the drive signal of a high level is supplied from the second buffer circuit 7 to the gate electrode of the PMOS transistor 81 of the second switch circuit 8. As a result, the PMOS transistor 81 is kept OFF, and the shunt circuit 9 may be retained in an OFF state for a predetermined time. That is, with respect to the variation or the like of the power supply voltage when the power supply starts faster than the ESD surge, which is not the ESD surge, a state where the shunt circuit 9 does not unintentionally operate is maintained.

After a predetermined time, for example, 1 μS which is set by the time constant of the first trigger circuit 3, a reset signal of a high level is supplied from the inverter 41 of a first stage of the first buffer circuit 4 to the NMOS transistor 102, and the NMOS transistor 102 is turned on. As a result, the level of the input signal of an input terminal of the inverter 71 of a first stage of the second buffer circuit 7 changes to a low level, and the drive signal of a low level is supplied from the second buffer circuit 7 to the gate electrode of the PMOS transistor 81. Accordingly, the PMOS transistor 81 returns to an ON state.

According to the present embodiment, although the time constant of the second trigger circuit 6 is set to a small value, the PMOS transistor 81 which configures the second switch circuit 8 may be maintained by an operation of the retaining unit 10 in an OFF state for the predetermined time, and thus, the unintentional operation of the electrostatic protection circuit due to a rapidly transitional variation or the like of the power supply voltage, which is not the ESD surge, is avoided.

A conductivity type of the MOS transistor which configures the first and second switch circuits 5 and 8 may be appropriately changed. According to the change of the conductivity type, the number of inverters which configure the first and second buffer circuits 4 and 7 is adjusted. In addition, the first and second buffer circuits are not limited to the inverters. In addition, the first and second switch circuits 5 and 8 may be configured using bipolar transistors. When the bipolar transistor is used, the main current path is formed by an emitter-collector current path, and a control electrode is formed by a base electrode. At this time, a configuration in which an NPN transistor is used instead of the NMOS transistor from the relationship of the bias may be made.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrostatic protection circuit, comprising:
a first trigger circuit connected between a first power supply terminal and a second power supply terminal and configured to output a first trigger signal;
a second trigger circuit connected between the first power supply terminal and the second power supply terminal, in parallel with the first trigger circuit, and configured to output a second trigger signal;
a first buffer circuit configured to output a first drive signal in response to the first trigger signal;
a second buffer circuit configured to output a second drive signal in response to the second trigger signal; and
a first switch circuit and a second switch circuit connected in series between the first and second power supply terminals,
wherein a conduction state of the first switch circuit is controlled by the first drive signal, and a conduction state of the second switch circuit is controlled by the second drive signal.

2. The electrostatic protection circuit according to claim 1, wherein when a predetermined power supply voltage is applied between the first and second power supply terminals, the first buffer circuit outputs a signal which turns the first switch circuit OFF, and the second buffer circuit outputs a signal which turns the second switch circuit ON.

3. The electrostatic protection circuit according to claim 1, wherein the first trigger circuit and the second trigger circuit each include a resistor and a capacitor connected in series, and a time constant of the first trigger circuit is larger than a time constant of the second trigger circuit.

4. The electrostatic protection circuit according to claim 1, further comprising:
a retaining unit that retains a level of the second trigger signal for a predetermined time.

5. The electrostatic protection circuit according to claim 4, wherein the second buffer circuit includes a first inverter, and
the retaining unit includes a second inverter that is connected in reverse-parallel to the first inverter.

6. The electrostatic protection circuit according to claim 4, wherein the retaining unit is reset by the first trigger signal.

7. The electrostatic protection circuit according to claim 1,
wherein the first switch circuit includes an NMOS transistor, a source of which is connected to the second power supply terminal, and
the second switch circuit includes a PMOS transistor, a source of which is connected to the first power supply terminal and a drain of which is connected to a drain of the NMOS transistor.

8. The electrostatic protection circuit according to claim 1, wherein at least one the first and second switches is a bipolar transistor.

9. The electrostatic protection circuit according to claim 1, wherein at least one of the first and second switches is a metal-oxide-semiconductor field effect transistor.

10. The electrostatic protection circuit according to claim 1, wherein the first buffer circuit comprises a plurality of CMOS inverters connected in series.

11. The electrostatic protection circuit according to claim 1, wherein
the first switch includes an NMOS transistor having a source electrode and a back gate electrode each connected to the second power supply terminal and a gate electrode connected to the first buffer circuit, and
the second switch includes a PMOS transistor having a source electrode and a back gate electrode each connected to the first power supply terminal, a gate electrode connected to the second buffer circuit, and a drain electrode connected to a drain electrode of the NMOS transistor included in the first switch.

12. An electrostatic protection circuit, comprising:
a first switch and second switch connected in series between two nodes;
a first trigger circuit and second trigger circuit configured to control, respectively, the first switch and the second switch to provide a closed circuit path between the two nodes upon occurrence of an ESD event and to maintain an open circuit path otherwise.

13. The electrostatic protection circuit according to claim 12, wherein
the first trigger circuit has a first time constant and the second trigger circuit has a second time constant,
the first time constant corresponding to an expected voltage rise caused by an ESD event,
the second time constant being less than the first time constant.

14. The electrostatic protection circuit according to claim 12, wherein
the first switch is normally OFF and the second switch is normally ON, and
the first trigger circuit closes the first switch when the ESD event occurs.

15. The electrostatic protection circuit according to claim 12, wherein
the first switch is normally OFF and the second switch is normally ON, and
the second trigger circuit opens the second switch when a power supply voltage variation event other than the ESD event occurs.

16. The electrostatic protection circuit according to claim 12, wherein
the first switch is normally OFF and the second switch is normally ON, and
the second trigger circuit opens the second switch for a predetermined time after a power supply voltage variation event other than the ESD event occurs.

17. The electrostatic protection circuit according to claim 12, further comprising:
a first buffer circuit between the first trigger circuit and the first switch; and
a second buffer circuit between the second trigger circuit and the second switch.

18. A method for protecting a circuit, the method comprising:
generating a first trigger signal according to a first time constant;
generating a second trigger signal according to a second time constant, the second time constant being shorter than the first time constant; and
closing a circuit path based on the first trigger and the second trigger when the duration of an event is about the same time as the first time constant; and
maintaining the circuit path in open state otherwise.

19. The method according to claim 18, wherein the first time constant is set to correspond to the duration of an ESD event.

20. The method according to claim 18, wherein the second time constant is set to correspond to the duration of a power supply voltage variation corresponding to power supply startup.
